(19) United States
(12) Patent Application Publication
(10) Pub. No.: US 2026/0179574 A1
(43) Pub. Date: Jun. 25, 2026

(54) Gamma Voltage Generation Circuit and Display Device Including the Same

(71) Applicant: LG Display Co., Ltd., Seoul (KR)

(72) Inventors: Jung Jae Kim, Paju-si (KR); In Rae Park, Paju-si (KR); Zong Gun Oh, Paju-si (KR)

(21) Appl. No.: 19/346,551

(22) Filed: Sep. 30, 2025

(30) Foreign Application Priority Data
Dec. 23, 2024 (KR) 10-2024-0193821

(51) Int. Cl. G09G 3/3291; G09G 3/32

(52) U.S. Cl. CPC G09G 3/3291; G09G 3/32; G09G 2300/0814; G09G 2310/027; G09G 2310/0275; G09G 2330/021; G09G 2330/028

(57) ABSTRACT

A gamma voltage generation circuit according to an embodiment and a display device including the same are disclosed. A gamma voltage generation circuit includes a first resistor string including a plurality of resistors connected in series and configured to generate a gamma reference voltage through a voltage division node between the predetermined resistors; a gamma buffer configured to output the generated gamma reference voltage; and a driving circuit configured to generate an enable signal for enabling or disabling the gamma buffer based on the voltage of an output node of the gamma buffer.

### CROSS-REFERENCE TO RELATED APPLICATION

This application claims priority to and the benefit of Korean Patent Application No. 10-2024-0193821, filed on Dec. 23, 2024, the disclosure of which is incorporated herein by reference in its entirety.

### BACKGROUND

### Field

The present disclosure relates to a gamma voltage generation circuit and a display device including the same.

### Discussion of Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In organic light-emitting display devices, organic light-emitting diodes (referred to as “OLEDs”) are formed in each of pixels. These organic light-emitting display devices not only respond quickly and have excellent light-emitting efficiency, luminance, and viewing angle, but also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a gate signal, such as a scan signal and emission signal to the display panel, and a data driver that supplies a data signal to the display panel.

### SUMMARY

In such a case, a data driver generates a data voltage by using a gamma voltage generated from a gamma voltage generation circuit. However, since the gamma voltage supplied to the data driver from the gamma voltage generation circuit must be maintained at all times, a lot of power consumption is required, and the power consumption required to maintain the gamma voltage at all times accounts for most of the total power consumption of the gamma voltage generation circuit.

Therefore, measures are needed to reduce the power consumption required in the gamma voltage generation circuit.

The present disclosure is directed to solving all the above-described necessity and problems.

The present disclosure provides a gamma voltage generation circuit capable of reducing current consumption and a display device including the same.

It should be noted that objects of the present disclosure are not limited to the above-described objects, and other objects of the present disclosure will be apparent to those skilled in the art from the following descriptions.

A gamma voltage generation circuit according to embodiments of the present disclosure may include a first resistor string including a plurality of resistors connected in series and configured to generate a gamma reference voltage through a voltage division node between the predetermined resistors; a gamma buffer configured to output the generated gamma reference voltage; and a driving circuit configured to generate an enable signal for enabling or disabling the gamma buffer based on the voltage of an output node of the gamma buffer.

A display device according to embodiments of the present disclosure may include a display panel in which having data lines, gate lines intersecting with the data lines, and pixels are arranged; a gamma voltage generation circuit configured to output grayscale-specific gamma compensated voltages; a data driver configured to convert pixel data of an input image into the grayscale-specific gamma compensated voltages to generate data voltages and output the generated data voltages to the data lines, wherein the gamma voltage generation circuit includes a first resistor string including a plurality of resistors connected in series and configured to generate a gamma reference voltage through a voltage division node between the predetermined resistors; a gamma buffer configured to output the generated gamma reference voltage; and a driving circuit configured to generate an enable signal for enabling or disabling the gamma buffer based on the voltage of an output node of the gamma buffer.

A display device according to another embodiment of the present disclosure comprises a display panel including data lines, gate lines intersecting with the data lines, and pixels; a gamma voltage generation circuit configured to output grayscale-specific gamma compensated voltages; and a data driver configured to convert pixel data of an input image into the grayscale-specific gamma compensated voltages to generate data voltages and output the generated data voltages to the data lines, wherein the gamma voltage generation circuit includes a first resistor string including a plurality of resistors connected in series and configured to generate a gamma reference voltage through a voltage division node between a predetermined set of resistors; and a plurality of gamma buffers including at least a first gamma buffer and a second gamma buffer, wherein the first gamma buffer is enabled but the second gamma buffer is disabled responsive to the pixel data of the input image being at a first grayscale level, and wherein the second gamma buffer is enabled but the first gamma buffer is disabled responsive to the pixel data of the input image being at a second grayscale level.

The plurality of gamma buffers may further include a third gamma buffer, wherein the third gamma buffer is enabled but both the first gamma buffer and the second gamma buffer are disabled responsive to the pixel data of the input image being at a third grayscale level between than the first grayscale level and the second grayscale level. The display device may further comprise a driving circuit configured to generate an enable signal for enabling or disabling the plurality of gamma buffers based on voltages of the output nodes of the gamma buffers.

The present disclosure may reduce power consumption by enabling the gamma buffer when the voltage of the output node of the gamma buffer in the gamma voltage generation circuit is out of a predetermined range and by disabling the gamma buffer when it is within the predetermined range.

The present disclosure may not require a separate algorithm for analyzing an image data in the timing controller and a separate communication for transmitting control information according to the analysis result.

Since the present disclosure may reduce power consumption, low power operation is possible.

The effects of the present specification are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one embodiment of the present disclosure;

FIGS. 2 to 3 are diagrams illustrating a gamma voltage generation circuit according to an embodiment of the present disclosure;

FIGS. 4A to 4B and FIG. 5 are diagrams for illustrating the principle of operation of the driving circuit; and

FIGS. 6A to 6B and FIGS. 7 to 10 are diagrams for illustrating the operating principle of the gamma voltage generation circuit.

### DETAILED DESCRIPTION OF EXEMPLARY EMBODIMENTS

Advantages and features of the present specification and methods of achieving them will become apparent with reference to preferable embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned below, may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

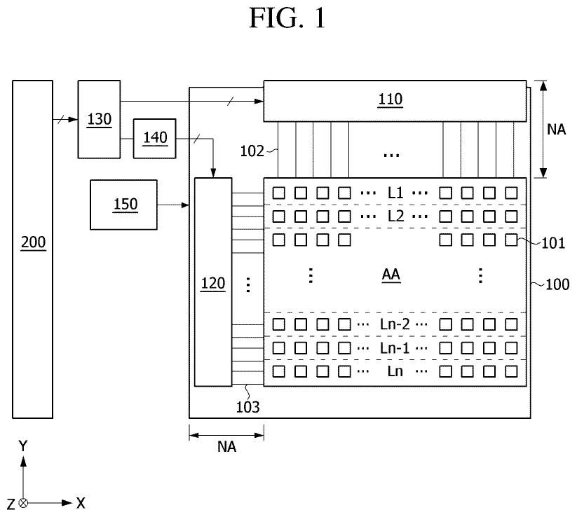

FIG. 1 is a block diagram illustrating a display device according to one embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage required for driving pixels 101 to the pixels 101.

Each of the pixels 101 may include a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 200 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The power supply 150 may further include a gamma voltage generation circuit. The gamma voltage generation circuit receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals.

The timing controller 130 receives digital video data of an input image and a timing signal synchronized with this data from the host system 200. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1 H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 200 may include a main board of one of a television system, a set-top box, a navigation system, a personal computer (PC), a vehicle system, a mobile terminal, and a wearable terminal. The host system 200 may scale an image signal from a video source according to the resolution of the display panel 100, and may transmit it to the timing controller 130 together with the timing signals.

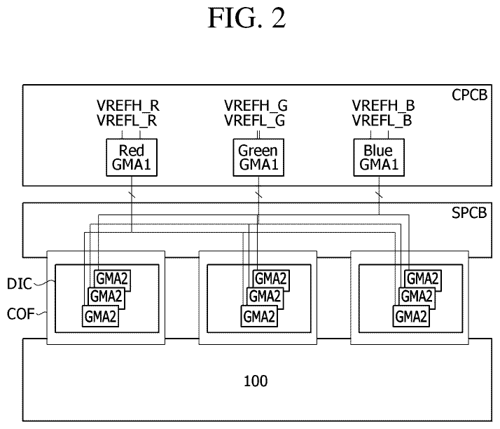

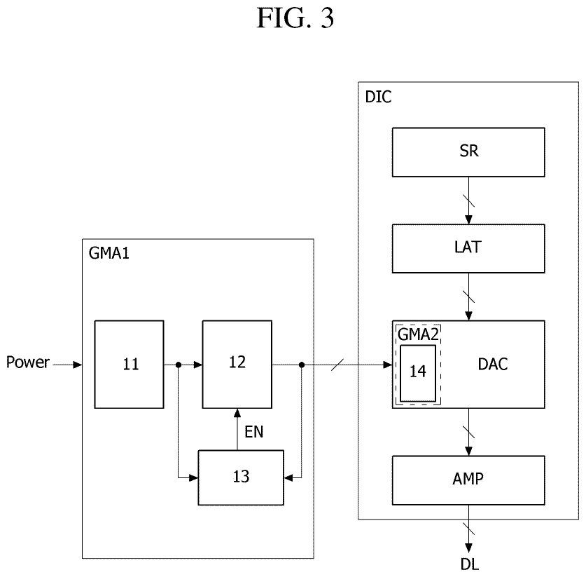

FIGS. 2 to 3 are diagrams illustrating a gamma voltage generation circuit according to an embodiment of the present disclosure.

Referring to FIGS. 2 to 3, a gamma voltage generation circuit according to an embodiment may include a first gamma part GMA1 and a second gamma part GMA2. The first gamma part GMA1 may be arranged on a control PCB CPCB, and the second gamma part GMA2 may be disposed arranged on a drive IC DIC.

The first gamma part GMA1 may receive high potential gamma reference voltages REFH_R, REFH_G and REFH_B and a low potential gamma reference voltages REFL_R, REFL_G and REFL_B as inputs, and may output a plurality of gamma reference voltages by using the high potential gamma reference voltages REFH_R, REFH_G and REFH_B and the low potential gamma reference voltages REFL_R, REFL_G and REFL_B. In such a case, The gamma reference voltages may have different voltage levels, or at least some of them may be the same.

The first gamma part GMA1 may include a first resistor string 11, a gamma buffer 12, and a driving circuit 13.

The first resistor string 11 may generate a color-specific gamma reference voltage. The first resistor string 11 may include, but is not limited to, a plurality of resistors connected in series.

The gamma buffer 12 may output the generated color-specific gamma reference voltage. The gamma buffer 12 may be connected to an output terminal of the first resistor string 11, may receive the color-specific gamma reference voltage generated by the first resistor string 11, and may output the received color-specific gamma reference voltage. The color-specific gamma reference voltage output from the gamma buffer 12 may be supplied to the second gamma part GMA2.

The driving circuit 13 may generate an enable signal EN for enabling or disabling the gamma buffer 12 based on the amount of fluctuation in the color-specific gamma reference voltage output from the gamma buffer 12, and may apply the generated enable signal EN to the gamma buffer 12.

For example, the gamma buffer 12 may be enabled if the enable signal EN is ‘H(High)=1’ when the gamma reference voltage rises or falls outside a predetermined output range, and the gamma buffer 12 may be disabled if the enable signal EN is ‘L(Low)=0’ when the gamma reference voltage remains within the output range.

The second gamma part GMA2 may receive gamma reference voltages from the first gamma part GMA1, and may generate a grayscale-specific gamma compensated voltage using the received gamma reference voltages.

The second gamma part GMA2 may include a second resistor string 14. The second resistor string 14 may include, but is not limited to, a plurality of resistors connected in series.

A DA conversion part DAC in the drive IC may use the pixel data, which is digital data, to select a gamma compensated voltage of the second resistor string 14 and to generate it as a data voltage for the pixel data.

The amplifier part AMP may supply the generated data voltage to the data line DL for each channel.

The drive IC may include a data driver, and the data driver may include a shift register SR, a latch LAT, the DA conversion part DAC and the amplifier part AMP.

The shift register SR may shift a clock input from the timing controller to generate a sampling clock, and may sequentially output the generated sampling clock to the latches LAT.

The latches LAT may sample and store pixel data of the input image according to the timing of the sequentially input sampling clock, and may simultaneously output the stored pixel data.

The DA converters DAC may select a gamma compensation voltage using pixel data output from the latch (LAT) and convert the selected gamma compensation voltage into a data voltage for the pixel data.

The amplifier AMP may amplify the data voltage for the pixel data converted by the DA converters DAC, and may output the amplified data voltage to the data lines through the output terminals.

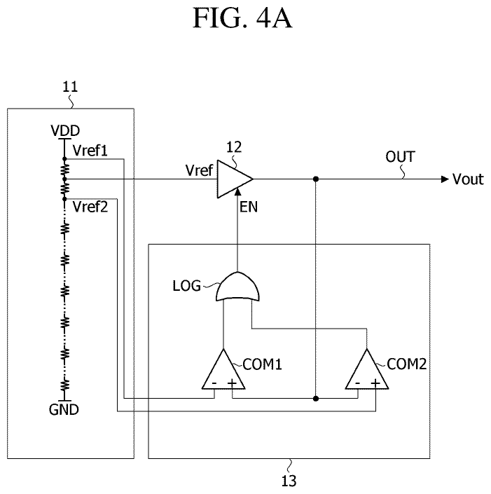

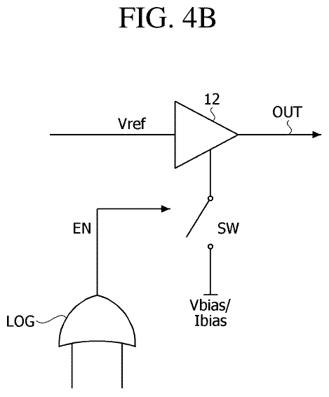

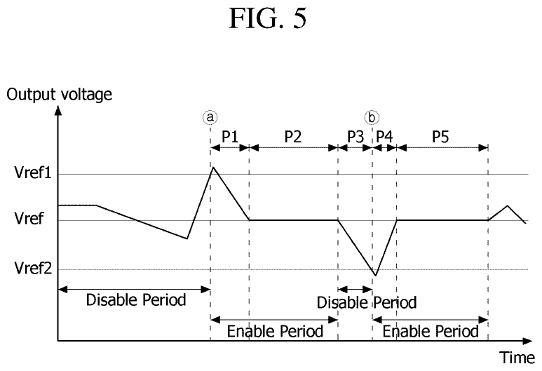

FIGS. 4A to 4B and FIG. 5 are diagrams for illustrating the principle of operation of the driving circuit.

Referring to FIG. 4A, the driving circuit 13 according to an embodiment may include a first comparator COM1, a second comparator COM2 and a logic gate LOG.

The first comparator COM1 may receive a first reference voltage Vref1 set based on a voltage division node in the first resistor string 11 of the first gamma part GMA1 and a gamma voltage Vout output from the first gamma buffer 12, and may output a first state value by comparing the first reference voltage Vref1 and the gamma voltage Vout. Here, the first reference voltage Vref1 may be set to a voltage that is higher than the voltage Vref of the voltage division node by a predetermined magnitude.

In such a case, the first comparator COM1 may receive the first reference voltage Vref1 via the inverting (−) input terminal and the voltage Vout of the output node OUT of the first gamma buffer 12 via the non-inverting (+) input terminal.

For example, the first comparator COM1 may output the first state value having a logic low-level (e.g., ‘L=0’) when the first reference voltage Vref1 is higher than the voltage Vout of the output node OUT, and may output the first state value having a logic high-level (e.g., ‘H=1’) when the first reference voltage is lower than the voltage Vout of the output node OUT.

The second comparator COM2 may receive a second reference voltage Vref2 set based on the voltage division node in the first resistor string 11 and the voltage Vout of the output node OUT of the first gamma buffer 12, and may output a second status value by comparing the second reference voltage Vref2 and the voltage Vout of the output node OUT. Here, the second reference voltage Vref2 may be set to a voltage that is lower than the voltage Vref of the voltage division node by a predetermined magnitude.

In such a case, the second comparator COM2 may receive the voltage Vout of the output node OUT of the first gamma buffer 12 via the inverting (−) input terminal and the second reference voltage Vref2 via the non-inverting (+) input terminal.

For example, the second comparator COM2 may output the second state value having a logic low-level (e.g., ‘L=0’) when the second reference voltage Vref2 is lower than the voltage Vout of the output node OUT, and may output the second state value having a logic high-level (e.g., ‘H=1’) when the second reference voltage Vref2 is higher than the voltage Vout of the output node OUT.

The logic gate LOG may receive the first state value output from the first comparator COM1 and the second state value output from the second comparator COM2, and may output an enable signal EN based on the received first state value and the received second state value. Such a logic gate LOG may be formed of, for example, an OR gate, but not limited thereto.

For example, the logic gate LOG may output the enable signal EN having a logic low-level if both the first state value and the second state value have a logic low-level, and may output the enable signal EN having a logic high-level if either the first state value or the second state value has a logic high-level.

As shown in FIG. 4B, a switch element SW may be provided to apply or supply a bias current Ibias and/or a bias voltage Vbias of the gamma buffer 12. The switch element SW may be turned on or off by an enable signal EN to enable or disable the gamma buffer 12. However, it is not necessarily limited to this configuration.

In one example, when there is no fluctuation in the voltage of the output node OUT of the first gamma buffer 12 in a particular grayscale area and thus the voltage of the output node OUT of the first gamma buffer 12 remains between the first reference voltage Vref1 and the second reference voltage Vref2, the first comparator COM1 in the driving circuit may output the first state value having a logic low-level L, and the second comparator COM2 may output the second state value having a logic low-level L. Thus, the logic gate LOG may output the enable signal EN having a logic low-level L, the switch element SW may be turned off, and then the gamma buffer 12 may be disabled.

As another example, if a relatively high grayscale voltage is applied and then changed to a low grayscale voltage, a sinking current may be required because the voltage of the output node OUT of the first gamma buffer 12 connected to the data line over which the relatively high grayscale voltage was applied is higher than the first reference voltage Vref1. In other words, when the voltage of the output node OUT of the first gamma buffer 12 is higher than the first reference voltage Vref1, the first comparator COM1 may output the first state value having a logic high-level H and the second comparator COM2 may output the second state value having a logic low-level L. Thus, the logic gate LOG may output the enable signal EN having a logic high-level H, the switch element SW may be turned on, and then the gamma buffer 12 may be enabled. In other words, when the output voltage Vout of the first gamma buffer 12 is higher than the first reference voltage Vref1, the enable signal EN outputs a logic high-level H, and then the gamma buffer 12 may be enabled.

When the gamma buffer 12 is enabled and the gamma reference voltage Vref is output for a period of time, the voltage of the output node OUT that was higher than the first reference voltage Vref1 may drop to the gamma reference voltage Vref.

In other words, the first gamma buffer 12 may be enabled during the first period P1 from time (a) as shown in FIG. 5 to cause the output voltage Vout to fall to the gamma reference voltage Vref. For example, the driving circuit 13 may provide a logic high-level enable signal EN to the first gamma buffer 12 during the preset enable period P1 to P2, and the first gamma buffer 12 may remain enabled during the enable period P1 to P2. When the output voltage Vout becomes the gamma reference voltage Vref and the enable signal EN transitions to a logic low-level after the end of the enable period P1 to P2, the first gamma buffer 12 may be disabled.

For example, the enable period P1 to P2 may be, but is not limited to, 1H.

During the third period P3, the output voltage Vout may have a voltage level within a range between the first reference voltage Vref1 and the second reference voltage Vref2, and the enable signal EN may have a logic low-level. That is, the third period P3 may be the disable period of the first gamma buffer 12. During the disable period, the output voltage Vout may be lowered by disabling (e.g., floating) the first gamma buffer 12.

In still another example, if a relatively low grayscale voltage is applied and then changed to a high grayscale voltage, a sourcing current may be required because the output voltage Vout of the first gamma buffer 12 connected to the data line over which the relatively low grayscale voltage was applied is lower than the second reference voltage Vref2. In other words, when the voltage of the output node OUT of the first gamma buffer 12 is lower than the second reference voltage Vref2, the first comparator COM1 may output the first state value having a logic low-level L and the second comparator COM2 may output the second state value having a logic high-level H. Thus, the logic gate LOG may output the enable signal EN having a logic high-level H, the switch element SW may be turned on, and then the gamma buffer 12 may be enabled. In other words, when the output voltage Vout of the first gamma buffer 12 is lower than the second reference voltage Vref2, the enable signal EN outputs a logic high-level H, and then the gamma buffer 12 may be enabled.

When the gamma buffer 12 is enabled and the gamma reference voltage Vref is output for a period of time, the voltage of the output node OUT that was lower than the second reference voltage Vref2 may increase to the gamma reference voltage Vref.

In such a case, the first gamma buffer 12 may be enabled during the fourth period P4 from time (b) as shown in FIG. 5 to cause the output voltage Vout to rise to the gamma reference voltage Vref. For example, the driving circuit 13 may provide a logic high-level enable signal EN to the first gamma buffer 12 during the preset enable period P4 to P5, and the first gamma buffer 12 may remain enabled during the enable period P4 to P5.

Here, the difference between the first reference voltage Vref and the gamma reference voltage Vref and the difference between the second reference voltage Vref2 and the gamma reference voltage Vref are shown equal to be the same, but are not limited thereto.

In the embodiment, rather than analyzing a pixel data in a timing controller and providing a data to enable or disable the gamma buffer according to the analysis result, it is intended to enable the gamma buffer when the voltage of the output node of the gamma buffer is out of the output range, and to disable the gamma buffer when it is within the output range.

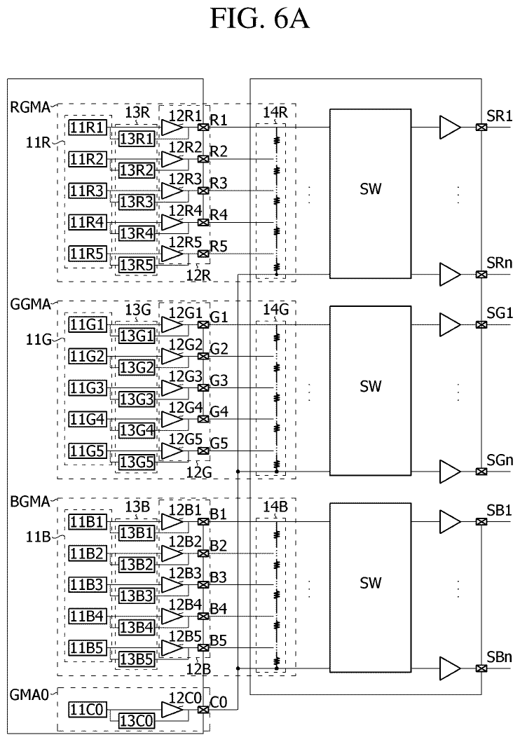

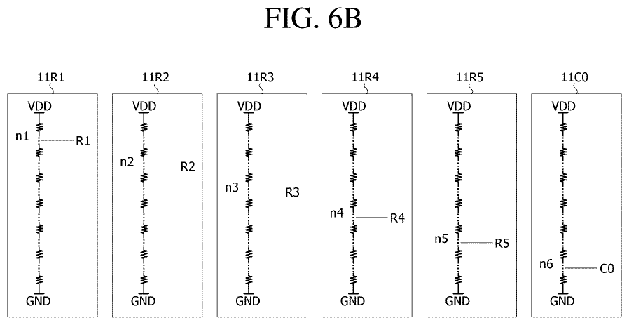

FIGS. 6A to 6B and FIGS. 7 to 10 are diagrams for illustrating the operating principle of the gamma voltage generation circuit.

Referring to FIG. 6A, a gamma voltage generation circuit according to an embodiment may include a color-specific gamma circuit, and the color-specific gamma circuit may include a red gamma circuit RGMA, a green gamma circuit GGMA and a blue gamma circuit BGMA.

The color-specific gamma circuits may share a gamma circuit GMA0 that outputs a gamma threshold voltage C0 of the lowest black grayscale. Thus, the color-specific gamma circuits may output six gamma reference voltages, for example, five grayscale-specific gamma reference voltages and one lowest grayscale gamma reference voltage. The gamma reference voltage of the lowest black grayscale may be output from the gamma circuit GMA0.

The red gamma circuit RGMA includes first resistor strings 11R and 11C0, gamma buffers 12R and 12C0, driving circuits 13R and 13C0, and a second resistor string 14R, the green gamma circuit GGMA includes first resistor strings 11G and 11C0, gamma buffers 12G and 12C0, driving circuits 13G and 13C0, and a second resistor string 14G, and a blue gamma circuit BGMA includes first resistor strings 11B and 11C0, gamma buffers 12B and 12C0, a driving circuits 13B and 13C0, and a second resistor string 14B.

In the color-specific gamma circuit, gamma reference voltages may be output at different voltage division nodes of the first resistor strings 11R, 11G, 11B and 11C0. For example, in a red gamma circuit RGMA, the six gamma reference voltages may be configured to generate at different voltage division nodes of the first resistor string 11R. As shown in FIG. 6B, a first gamma reference voltage R1 may be generated at a first voltage division node n1 of the first resistor string 11R1, a second gamma reference voltage R2 may be generated at a second voltage division node n2 of the first resistor string 11R2, a third gamma reference voltage R3 may be generated at a third voltage division node n3 of the first resistor string 11R3, a fourth gamma reference voltage R4 may be generated at a fourth voltage division node n4 of the first resistor string 11R4, a fifth gamma reference voltage R5 may be generated at a fifth voltage division node n5 of the first resistor string 11R5, and a sixth gamma reference voltage C0 may be generated at a sixth voltage division node n6 of the first resistor string 11C0.

Similarly, the first to sixth gamma reference voltages G1, G2, G3, G4, G5 and C0 may be output from the green gamma circuit GGMA, and the first to sixth gamma reference voltages B1, B2, B3, B4, B5 and C0 may be output from the blue gamma circuit BGMA.

A configuration in which six gamma reference voltages are output using six first resistor strings as shown in FIG. 6B is described herein as an example, but is not limited thereto. For example, a single first resistor string may be used to output six gamma reference voltages.

The color-specific gamma circuit may generate a grayscale-specific gamma compensated voltage based on the output gamma reference voltage.

In the DA conversion part in the drive IC, one gamma compensated voltage may be selected as an analog data voltage by the pixel data among the grayscale-specific gamma reference voltages and may be output.

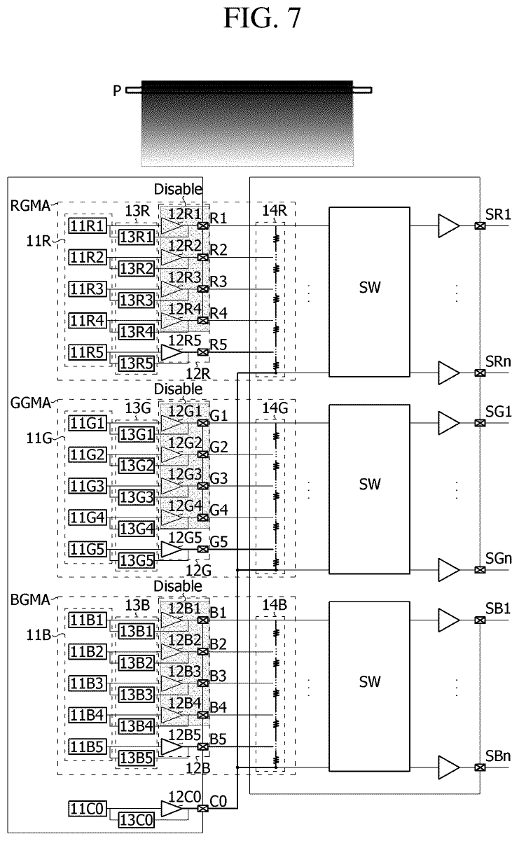

Referring to FIG. 7, when the line P of the image data is represented in the lower grayscale area, the first to fourth gamma buffers 12R1 to 12R 4 in the red gamma circuit, the first to fourth gamma buffers 12G1 to 12G4 in the green gamma circuit, and the first to fourth gamma buffers 12B1 to 12B4 in the blue gamma circuit, which output the gamma reference voltages of the middle grayscale and upper grayscale areas, are disabled; and the fifth gamma buffer 12R5 in the red gamma circuit, the fifth gamma buffer 12G5 in the green gamma circuit, the fifth gamma buffer 12B5 in the blue gamma circuit and the common gamma buffer 12C0, which output the gamma reference voltages of the lower grayscale area, are enabled.

In other words, there is no voltage fluctuation at the output nodes of the gamma buffers in the color-specific gamma circuit from which the gamma reference voltages of the middle grayscale and upper grayscale areas are output. Thus, each gamma buffer is disabled because the voltage at its output node is maintained between the first reference voltage and the second reference voltage.

On the other hand, voltage fluctuations occur at the output nodes of the gamma buffers in the color-specific gamma circuit from which the gamma reference voltages of the lower grayscale area are output. Thus, each gamma buffer is enabled because the voltage at its output node is out of the range between the first reference voltage and the second reference voltage.

Based on the gamma reference voltages R5, G5, B5 and C0 generated by the enabled color-specific fifth gamma buffers 12R5, 12G5 and 12B5 and the common gamma buffer 12C0, a gamma compensated voltage is generated and output as the data voltage for the pixel data.

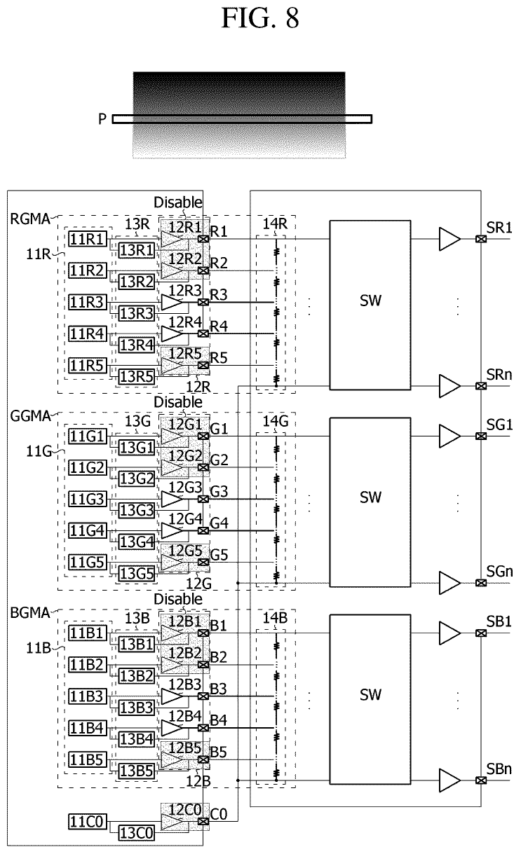

Referring to FIG. 8, when the P line of the image data is represented in the middle grayscale area, the first and second gamma buffers 12R1 and 12R2 and the fifth gamma buffer 12R5 in the red gamma circuit, the first and second gamma buffers 12G1 and 12G2 and the fifth gamma buffer 12G5 in the green gamma circuit, the first and second gamma buffers 12B1 and 12B2 and the fifth gamma buffer 12B5 in the blue gamma circuit, and the common gamma buffer 12C0, from which the gamma reference voltages of the upper grayscale and lower grayscale areas are output, are disabled; and the third and fourth gamma buffers 12R3 and 12R4 in the red gamma circuit, the third and fourth gamma buffers 12G3 and 12G4 in the green gamma circuit, and the third and fourth gamma buffers 12B3 and 12B4 in the blue gamma circuit, which output the gamma reference voltages of the middle grayscale area, are enabled.

In other words, there is no voltage fluctuation at the output nodes of the gamma buffers in the color-specific gamma circuit from which the gamma reference voltages of the upper grayscale and lower grayscale areas are output. Thus, each gamma buffer is disabled because the voltage at its output node is maintained between the first reference voltage and the second reference voltage.

On the other hand, voltage fluctuations occur at the output nodes of the gamma buffers in the color-specific gamma circuit from which the gamma reference voltages of the middle grayscale area are output. Thus, each gamma buffer is enabled because the voltage at its output node is out of the range between the first reference voltage and the second reference voltage.

Based on the gamma reference voltages R3 to R4, G3 to G4, and B3 to B4 generated by the enabled color-specific third and fourth gamma buffers 12R3 to 12R4, 12G3 to 12G4, and 12B3 to 12B4, a gamma compensated voltage is generated and output as the data voltage for the pixel data.

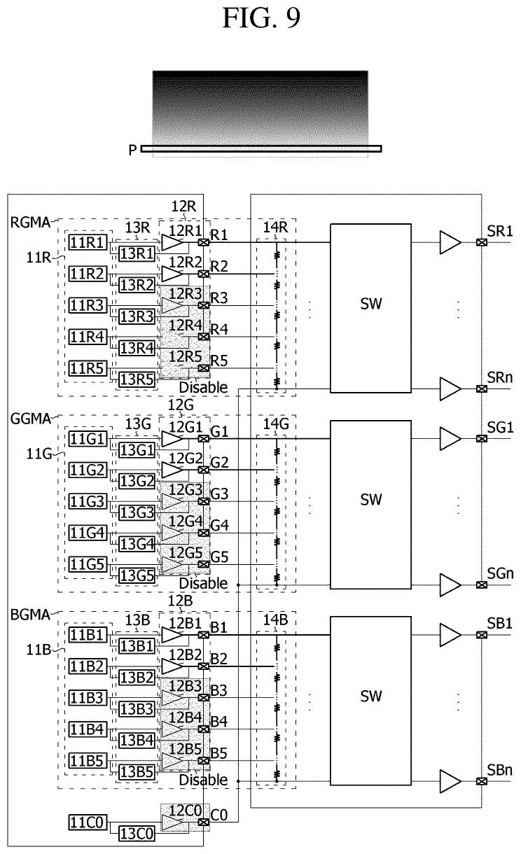

Referring to FIG. 9, when the P line of the image data is represented in the upper grayscale area, since the gamma reference voltages of the middle grayscale and lower grayscale areas are not used, the third to fifth gamma buffers 12R3 to 12R5 in the red gamma circuit, the third to fifth gamma buffers 12G3 to 12G5 in the green gamma circuit, the third to fifth gamma buffers 12B3 to 12B5 in the blue gamma circuit, and the common gamma buffer 12C0 are disabled; and the first and second gamma buffers 12R1 and 12R2 in the red gamma circuit, the first and second gamma buffers 12G1 and 12G2 in the green gamma circuit, and the first and second gamma buffers 12B1 and 12B2 in the blue gamma circuit, which output the gamma reference voltages of the upper grayscale area, are enabled.

In other words, there is no voltage fluctuation at the output nodes of the gamma buffers in the color-specific gamma circuit from which the gamma reference voltages of the middle grayscale and lower grayscale areas are output. Thus, each gamma buffer is disabled because the voltage at its output node is maintained between the first reference voltage and the second reference voltage.

On the other hand, voltage fluctuations occur at the output nodes of the gamma buffers in the color-specific gamma circuit from which the gamma reference voltages of the upper grayscale area are output. Thus, each gamma buffer is enabled because the voltage at its output node is out of the range between the first reference voltage and the second reference voltage.

Based on the gamma reference voltages R1 to R2, G1 to G2, and B1 to B2 generated by the enabled color-specific first and second gamma buffers 12R1 to 12R2, 12G1 to 12G2 and 12B1 to 12B2, a gamma compensated voltage is generated and output as the data voltage for the pixel data.

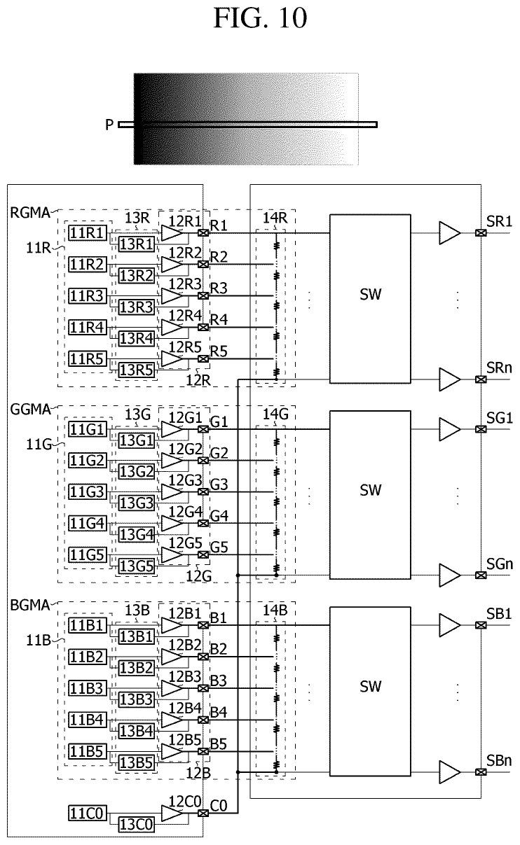

Referring to FIG. 10, when the image data is represented in all grayscale areas, the first to fifth gamma buffers 12R1 to 12R5 in the red gamma circuit, the first to fifth gamma buffers 12G1 to 12G5 in the green gamma circuit, the first to fifth gamma buffers 12B1 to 12B5 in the blue gamma circuit, and the common gamma buffer 12C0 are all enabled.

Voltage fluctuations occur at the output nodes of the gamma buffers in the color-specific gamma circuit from which the gamma reference voltages of for all grayscale areas are output. Thus, each gamma buffer is enabled because the voltage at its output node is out of the range between the first reference voltage and the second reference voltage.

Based on the gamma reference voltages R1 to R5, G1 to G5, B1 to B5, and C0 generated by the enabled color-specific first to fifth gamma buffers 12R1 to 12R5, 12G1 to 12G5 and 12B1 to 12B5, and the common gamma buffer 12C0, a gamma compensated voltage is generated and output as the data voltage for the pixel data.

As described above, in the embodiment, when image data is not expressed in all grayscale areas but is expressed in only some grayscale areas, only some gamma buffers in the color-specific gamma circuit may be enabled. Therefore, the reduction in power consumption may vary depending on the pattern of the image data.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gamma voltage generation circuit comprising:
a first resistor string including a plurality of resistors connected in series and configured to generate a gamma reference voltage through a voltage division node between the a predetermined set of resistors in the first resistor string;
a gamma buffer configured to output the generated gamma reference voltage; and
a driving circuit configured to generate an enable signal for enabling or disabling the gamma buffer based on the voltage of an output node of the gamma buffer.

2. The gamma voltage generation circuit according to claim 1, wherein:
the driving circuit is configured to determine a voltage magnitude of the output node of the gamma buffer by using the gamma reference voltage generated from the first resistor string and a first reference voltage and a second reference voltage set based on the gamma reference voltage,
the first reference voltage is set higher than the gamma reference voltage, and
the second reference voltage is set lower than the gamma reference voltage.

3. The gamma voltage generation circuit according to claim 2, wherein the driving circuit includes:
a first comparator configured to compare the first reference voltage with the voltage of the output node and to output a first state value;
a second comparator configured to compare the second reference voltage with the voltage of the output node and to output a second state value; and
a logic gate configured to perform a logic operation on the first state value and the second state value and to generate an enable signal having a voltage level according to the result of the logic operation.

4. The gamma voltage generation circuit according to claim 3, wherein:
the first comparator includes an inverting input terminal to which the first reference voltage is input and a non-inverting input terminal to which the voltage of the output node is input, and
the second comparator includes a non-inverting input terminal to which the second reference voltage is input and an inverting input terminal to which the voltage of the output node is input.

5. The gamma voltage generation circuit according to claim 4, wherein:
the first comparator outputs the first state value having a first logic level when the voltage of the output node is higher than the first reference voltage, and
the second comparator outputs the second state value having the first logic level when the voltage of the output node is lower than the second reference voltage.

6. The gamma voltage generation circuit according to claim 5, wherein the logic gate is implemented with an OR gate, and is configured to generate an enable signal having the first logic level for enabling the gamma buffer if either the first state value or the second state value has the first logic level.

7. The gamma voltage generation circuit according to claim 6, wherein the logic gate is configured to generate the enable signal having a second logic level for disabling the gamma buffer if both the first state value and the second state value have the second logic level.

8. The gamma voltage generation circuit according to claim 1, further comprising:
a second resistor string configured to divide the gamma reference voltages output from each of a plurality of gamma buffers to generate grayscale-specific gamma compensated voltages.

9. A display device comprising:
a display panel including data lines, gate lines intersecting with the data lines, and pixels;
a gamma voltage generation circuit configured to output grayscale-specific gamma compensated voltages;
a data driver configured to convert pixel data of an input image into the grayscale-specific gamma compensated voltages to generate data voltages and output the generated data voltages to the data lines,
wherein the gamma voltage generation circuit includes:
a first resistor string including a plurality of resistors connected in series and configured to generate a gamma reference voltage through a voltage division node between a predetermined set of resistors;
a gamma buffer configured to output the generated gamma reference voltage; and
a driving circuit configured to generate an enable signal for enabling or disabling the gamma buffer based on a voltage of an output node of the gamma buffer.

10. The display device according to claim 9, wherein:
the driving circuit is configured to determine a voltage magnitude of the output node of the gamma buffer by using the gamma reference voltage generated from the first resistor string and a first reference voltage and a second reference voltage set based on the gamma reference voltage,
the first reference voltage is set higher than the gamma reference voltage, and
the second reference voltage is set lower than the gamma reference voltage.

11. The display device according to claim 10, wherein the driving circuit includes:
a first comparator configured to compare the first reference voltage with the voltage of the output node and to output a first state value;
a second comparator configured to compare the second reference voltage with the voltage of the output node and to output a second state value; and
a logic gate configured to perform a logic operation on the first state value and the second state value and to generate an enable signal having a voltage level according to a result of the logic operation.

12. The display device according to claim 11, wherein:
the first comparator includes an inverting input terminal to which the first reference voltage is input and a non-inverting input terminal to which the voltage of the output node is input, and
the second comparator includes a non-inverting input terminal to which the second reference voltage is input and an inverting input terminal to which the voltage of the output node is input.

13. The display device according to claim 12, wherein:
the first comparator outputs the first state value having a first logic level when the voltage of the output node is higher than the first reference voltage, and
the second comparator outputs the second state value having the first logic level when the voltage of the output node is lower than the second reference voltage.

14. The display device according to claim 13, wherein the logic gate is implemented with an OR gate, and is configured to generate an enable signal having the first logic level for enabling the gamma buffer if either the first state value or the second state value has the first logic level.

15. The display device according to claim 14, wherein the logic gate is configured to generate the enable signal having a second logic level for disabling the gamma buffer if both the first state value and the second state value have the second logic level.

16. The display device according to claim 9, further comprising:
a second resistor string configured to divide the gamma reference voltages output from each of a plurality of gamma buffers to generate grayscale-specific gamma compensated voltages.

17. The display device according to claim 16, wherein:
the first resistor string, the gamma buffer, and the driving circuit are arranged on a CPCB (Control Printed Circuit Board), and
the second resistor string is arranged within the data driver.

18. A display device comprising:
a display panel including data lines, gate lines intersecting with the data lines, and pixels;
a gamma voltage generation circuit configured to output grayscale-specific gamma compensated voltages;
a data driver configured to convert pixel data of an input image into the grayscale-specific gamma compensated voltages to generate data voltages and output the generated data voltages to the data lines,
wherein the gamma voltage generation circuit includes:
a first resistor string including a plurality of resistors connected in series and configured to generate a gamma reference voltage through a voltage division node between a predetermined set of resistors; and
a plurality of gamma buffers including at least a first gamma buffer and a second gamma buffer,
wherein the first gamma buffer is enabled but the second gamma buffer is disabled responsive to the pixel data of the input image being at a first grayscale level, and
wherein the second gamma buffer is enabled but the first gamma buffer is disabled responsive to the pixel data of the input image being at a second grayscale level.

19. The display device of claim 18,
wherein the plurality of gamma buffers further include a third gamma buffer, and
wherein the third gamma buffer is enabled but both the first gamma buffer and the second gamma buffer are disabled responsive to the pixel data of the input image being at a third grayscale level between than the first grayscale level and the second grayscale level.

20. The display device of claim 18, further comprising a driving circuit configured to generate an enable signal for enabling or disabling the plurality of gamma buffers based on voltages of the output nodes of the gamma buffers.
